(19) United States
(12) Patent Application Publication
(10) Pub. No.: US 2007/0137327 A1
(43) Pub. Date: Jun. 21, 2007

(54) Valve device for a hydraulic servo-steering arrangement

(75) Inventor: Heinz-Dieter Heitzer, Heinsberg (DE)

Correspondence Address: TAROLLI, SUNDHEIM, COVELL & TUMMINO L.L.P., 1300 EAST NINTH STREET, SUITE 1700, CLEVEVLAND, OH, 44114, US

(73) Assignee: TRW Automotive GmbH

(21) Appl. No.: 11/602,532

(22) Filed: Nov. 21, 2006

(30) Foreign Application Priority Data
Nov. 24, 2005 (DE) 20 2005 018 390.3

(51) Int. Cl. F16H 21/00

(52) U.S. Cl. 74/25

(57) ABSTRACT

A valve device (10) for a hydraulic servo-steering arrangement includes two valve elements (18, 14) which can be rotated from a neutral position relative to each other, in order to thereby achieve the superimposition of an additional steering moment. The valve device (10) further includes a linear actuator (33) and a gear (20) coupling the two valve elements (18, 14) to each other. The gear (20) converts a linear stroke of the linear actuator (30) into a rotation. The gear (20) includes a first cogwheel (22) with teeth inclined in a first direction in relation to the axial direction of the cogwheel. The first cogwheel (20) is coupled to the first valve element (18). The gear (20) further includes a second cogwheel (30) with teeth inclined in a second direction opposed to the first direction. The second cogwheel (30) is axially displaceable by the linear actuator (33).

### TECHNICAL FIELD

The invention relates to a valve device for a hydraulic servo-steering arrangement.

### BACKGROUND OF THE INVENTION

From DE 10 2004 049 686 A1 a valve device is known comprising two valve elements which can be rotated from a neutral position relative to each other, in order to thereby achieve the superimposition of an additional steering moment. This valve further comprises a linear adjuster and a gear coupling the two valve elements to each other. The gear converts a linear stroke of the linear adjuster into a rotation. In order to superimpose on the servo assistance force provided by the user a servo assistance force determined by a control unit (additional steering moment), the valve sleeve of the valve device is not rigidly coupled with the output shaft, but rather is connected therewith by means of two planetary gears, in order to make possible an externally controllable rotation of the valve sleeve relative to the output shaft. A linear actuator can rotate a ring gear of one of the planetary gears via an arm so that a relative rotation between the valve sleeve and the input shaft is thereby automatically produced.

It is an object of the invention to simplify the relative rotation of two valve elements of a servo valve device for providing a superimposed torque.

### BRIEF SUMMARY OF THE INVENTION

According to the invention, a valve device for a hydraulic servo-steering arrangement comprises two valve elements which can be rotated from a neutral position relative to each other, in order to thereby achieve the superimposition of an additional steering moment. The valve device further comprises a linear actuator and a gear coupling the two valve elements to each other. The gear converts a linear stroke of the linear actuator into a rotation. The gear includes a first cogwheel with teeth inclined in a first direction in relation to the axial direction of the cogwheel. The first cogwheel is coupled to the first valve element. The gear further includes a second cogwheel having teeth inclined in a second direction opposed to the first direction. The second cogwheel is axially displaceable by the linear actuator. The gear according to the invention, which is arranged between the two valve elements, preferably between the valve sleeve (control sleeve) and the output shaft of the valve device, virtually shifts the setting of the relative angle between the two valve elements inside the valve to the control of an external linear displacement. In fact, only an axial displacement of the second cogwheel has to be carried out to rotate the first valve element. Owing to the oppositely inclined teeth of the first and second cogwheels, this displacement leads to a rotation of the first cogwheel and of the valve element which is coupled to it so as to be locked against relative rotation. The setting of the relative angle between the two valve elements is thereby greatly simplified compared with known solutions.

In addition, the invention has the advantage that interference forces acting on the gear, which result from the friction forces and flow forces in the valve device, are almost completely absorbed. In fact, with a small angle of inclination of the teeth, a low degree of reaction of the valve device is produced. Thereby, the requirement for a robust axial position regulation of the second cogwheel is provided on a very low force level. The functioning principle according to the invention makes it possible to use different drives for the linear actuator, i.e. also drive designs can be used which have proved to be successful in other fields. Depending on the design of the drive, the range of the possible practical conversions extends from low cost systems with low requirements as regards accuracy and dynamics of the external control, to systems with the highest quality of regulation.

It proves to be advantageous to bias the second cogwheel into a neutral position. The neutral position corresponds to a position in which the second cogwheel forces on the first element a position which the first valve element would assume if it were securely connected with the second valve element and no possibility were provided for superimposing an additional steering moment. The first valve element is rotatable from this neutral position by the second cogwheel with restoring forces having to be overcome for the relative rotation. The pre-stressing provides a greater reliability against failure of the valve device, especially when the linear actuator is not functioning. The second cogwheel, and therefore also the first cogwheel with the first valve element, then remain in their neutral position, so that the valve device can operate in a conventional manner.

An adjusting arrangement, by which the axial neutral position of the second cogwheel is adjustable, is expedient to balance out manufacturing tolerances.

According to a preferred embodiment of the invention, the gear further includes a third cogwheel coupled non-rotatably to the second valve element and a fourth cogwheel coupled non-rotatably to the second cogwheel. The third and the fourth cogwheel have oppositely inclined teeth, the teeth of the third cogwheel being inclined in the second direction and the teeth of the fourth cogwheel being inclined in the first direction. With such a gear a precise and reliable synchronous rotation of the two valve elements is able to be realized in a simple manner.

A particularly compact construction of the gear is produced in that the second cogwheel and the fourth cogwheel are constructed as a double pinion.

### BRIEF DESCRIPTION OF THE DRAWINGS

FIG. 1 shows a sectional side view of a valve device according to the invention;

FIG. 2 shows a top view onto the first and the second cogwheel of the valve device; and

FIGS. 3a to 3c show side views of the cogwheels of the valve device in various operating positions.

### DETAILED DESCRIPTION OF THE PREFERRED EMBODIMENTS

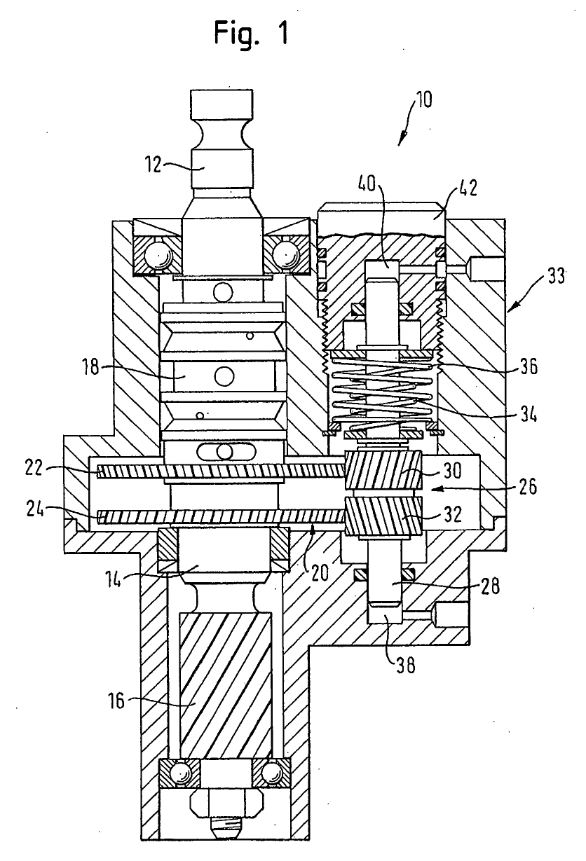

A valve device 10 according to the invention for a hydraulic servo-steering arrangement in a motor vehicle is illustrated in FIG. 1. In a known manner, the valve device 10 has an input shaft 12, connected with the steering wheel, and an output shaft 14 having a pinion 16. The output shaft 14 is coupled to the input shaft 12 by a torsion rod. The pinion 16 engages into a rack which is part of a steering gear. A section of the input shaft 12 which is provided with control grooves is arranged in a valve sleeve 18. The valve sleeve 18 is not coupled rigidly with the output shaft 14, but rather is mounted rotatably thereon. More precisely, the valve sleeve 18 is connected with the output shaft 14 via a gear 20 which will be explained in greater detail below.

A cogwheel 22, which will be referred to below as a valve sleeve cogwheel, is connected non-rotatably with the valve sleeve 18. The valve sleeve cogwheel 22 has oblique teeth with respect to the axial direction of the cogwheel. A further cogwheel 24 is non-rotatably connected with the output shaft 14 and is referred to below as an output shaft cogwheel. The output shaft cogwheel 24 is the same size and has as many teeth as the valve sleeve cogwheel 22, but the teeth of the output shaft cogwheel 24 are inclined in opposition with respect to the teeth of the valve sleeve cogwheel 22.

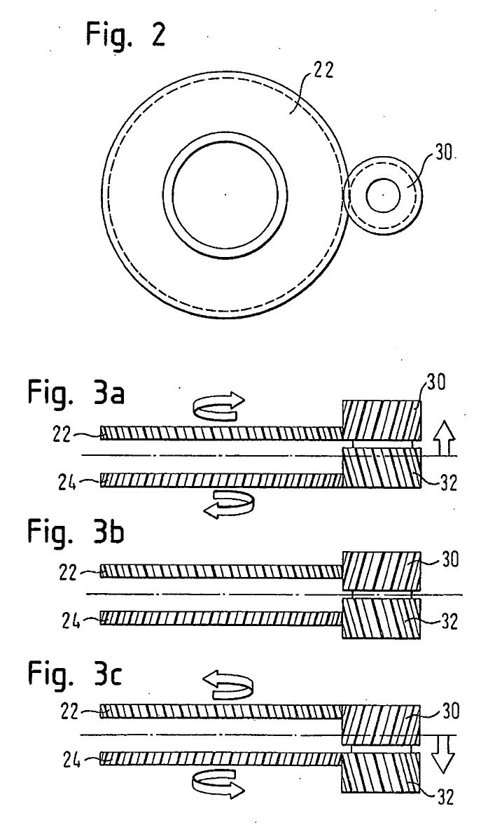

The two cogwheels 22, 24 cooperate with a double pinion 26, which is mounted on a shaft 28. The double pinion 26 consists of two cogwheels 30, 32 which are connected non-rotatably with each other, one of which meshes with the valve sleeve cogwheel 22 and the other with the output shaft cogwheel 24 (see also FIG. 2). The cogwheels 30, 32 have the same dimensions and the same number of teeth, but the teeth have opposite inclinations. In relation to the valve sleeve cogwheel 22 and the output shaft cogwheel 24, the teeth of the cogwheels 30 and 32 have an inclination which is opposed to the inclination of the meshing cogwheels 22 and 24, respectively. The tooth engagement and the rigid connection of the cogwheels 30, 32 of the double pinion 26 provide for the valve sleeve 18 to always assume a defined angle position, substantially free of play, in relation to the output shaft 14.

The shaft 28 is part of a linear actuator 30, with which the shaft 28 and therefore the double pinion 26 can be displaced axially in both directions, in relation to the longitudinal direction of the shaft 28. The cogwheels 30, 32 of the double pinion 26 have a greater axial height compared with the valve sleeve cogwheel 22 and the output shaft cogwheel 24. Two biased helical springs 34, 36 hold the double pinion 26 in the neutral position, shown in FIGS. 1 and 3b, in which the valve sleeve cogwheel 22 and the output shaft cogwheel 24 are aligned axially centrally to the cogwheels 30, 32 of the double pinion 26.

In the illustrated example embodiment, pressure chambers 38, 40 are provided at both ends of the shaft 28, which are able to be acted upon by oil under pressure, which can be taken from the hydraulic circuit of the servo-steering system. In this way, the shaft 28 can be displaced in the axial direction in proportion to the applied pressure. However, other drives are also possible for displacing the shaft 28, e.g. a proportional magnet acting with both sides. The use of an electromechanical linear actuator is likewise conceivable.

The mode of operation of the valve device 10 is described below. In normal steering operation, the double pinion 26 assumes the neutral position. The gear 20 is coordinated so that the valve sleeve 18 and the output shaft 14 are in a previously established neutral position. When the driver makes a steering movement, a hydraulic flow provided by a pump is controlled in a known manner through the relative rotation between the control grooves of the input shaft 12 and the valve sleeve 18 so that one of the two chambers of a hydraulic cylinder is acted upon with the flow of oil depending on the respective relative rotation between the input shaft 12 and the valve sleeve 18. The rotation of the valve sleeve 18 is transferred unchanged to the output shaft 14 via the gear 20.

When an electronic control unit detects that a superimposing of the steering moment is desirable, e.g. in order to make it easier for the driver to keep the vehicle on track, the gear 20 makes a rotation of the valve sleeve 18 on the output shaft 14 possible, in order to thus influence the controlling of the hydraulic flow which assists the steering power. For this, the double pinion 26 is moved axially by means of the linear actuator 30, as required, into one or other direction, as shown in FIGS. 3a and 3c. The width and the axial spacing of the cogwheels 22, 24, 30, 32 with respect to each other are coordinated so that the valve sleeve cogwheel 22 and the output shaft cogwheel 24 do not come out of engagement when the double pinion 26 is moved. Owing to the particular inclinations of the individual cogwheels 22, 24, 30, 32, the displacement of the double pinion 26 brings about an oppositely directed rotation of the valve sleeve cogwheel 22 and of the output shaft cogwheel 24, as indicated by arrows in FIGS. 3a and 3c. The valve sleeve 18 and the output shaft 14 are therefore rotated relative to each other, the extent of the rotation being determined by the stroke of the linear actuator 30.

If the linear actuator 30 fails, the double pinion 26 assumes the neutral position shown in FIG. 3b, owing to the pre-stressing by the springs 34, 36, and the valve device 10 can be operated further in a conventional manner, without the possibility of a superimposing of the steering moment.

An adjusting arrangement with an adjusting screw 42 allows the axial position of the shaft 28 to be adjusted, so that the neutral position of the double pinion 26 can still be altered after the valve device 10 is manufactured.

1. A valve device for a hydraulic servo-steering arrangement, comprising
two valve elements which can be rotated from a neutral position relative to each other, in order to thereby achieve the superimposition of an additional steering moment,
a linear actuator, and
a gear coupling the two valve elements to each other,
the gear converting a linear stroke of the linear actuator into a rotation, the gear including a first cogwheel with teeth inclined in a first direction in relation to the axial direction of the cogwheel, the first cogwheel being coupled to the first valve element,
the gear further including a second cogwheel having teeth inclined in a second direction opposed to the first direction, the second cogwheel being axially displaceable by the linear actuator.

2. The valve device according to claim 1, wherein one of the valve elements is a valve sleeve and the other valve element is an output shaft of the valve device.

3. The valve device according to claim 1, wherein the second cogwheel has a greater axial height than the first cogwheel.

4. The valve device according to claim 1, wherein the second cogwheel is mounted on an axially displaceable shaft of the linear actuator.

5. The valve device according to claim 4, wherein the shaft of the linear actuator is displaceable by hydraulic pressure application.

6. The valve device according to claim 4, wherein the shaft of the linear actuator is displaceable through influence of a magnet.

7. The valve device according to any of claim 1, wherein the linear actuator is an electromechanical linear actuator.

8. The valve device according to claim 1, wherein the second cogwheel is biased into an axial neutral position.

9. The valve device according to claim 8, further comprising an adjusting arrangement, by which the axial neutral position of the second cogwheel is adjustable.

10. The valve device according to claim 1, wherein the gear further includes a third cogwheel coupled non-rotatably to the second valve element, and a fourth cogwheel coupled non-rotatably to the second cogwheel.

11. The valve device according to claim 10, wherein the third cogwheel and the fourth cogwheel have oppositely inclined teeth.

12. The valve device according to claim 11, wherein the teeth of the third cogwheel are inclined in the second direction and the teeth of the fourth cogwheel are inclined in the first direction.

13. The valve device according to claim 10, wherein the second cogwheel and the fourth cogwheel are constructed as a double pinion.
